(19) United States
(12) Patent Application Publication
(10) Pub. No.: US 2015/0115200 A1
(43) Pub. Date: Apr. 30, 2015

(54) LIQUID CRYSTAL COMPOSITION, LIQUID CRYSTAL DISPLAY ELEMENT, AND LIQUID CRYSTAL DISPLAY

(71) Applicant: DIC CORPORATION, Tokyo (JP)

(72) Inventors: Joji Kawamura, Kita-adachi-gun (JP); Yoshinori Iwashita, Kita-adachi-gun (JP)

(73) Assignee: DIC CORPORATION, Tokyo (JP)

(21) Appl. No.: 14/396,491

(22) PCT Filed: Nov. 30, 2012
(86) PCT No.: PCT/JP2012/081092

§ 371 Date: Oct. 23, 2014

(51) Int. Cl. C09K 19/04; G02F 1/1341

(52) U.S. Cl. CPC C09K 19/0403; G02F 1/1341; G02F 2001/13415; G02F 2001/133397
USPC 252/299.63

(57) ABSTRACT

A liquid crystal composition having a negative dielectric anisotropy includes a dielectrically negative component (A) containing a compound represented by a general formula (1) below, and a component (B) that is a dielectrically neutral component containing at least one of compounds represented by a formula (2.1) and a formula (2.2) below. In the following formula, R¹ and R² each independently represent an alkyl group having 1 to 5 carbon atoms.

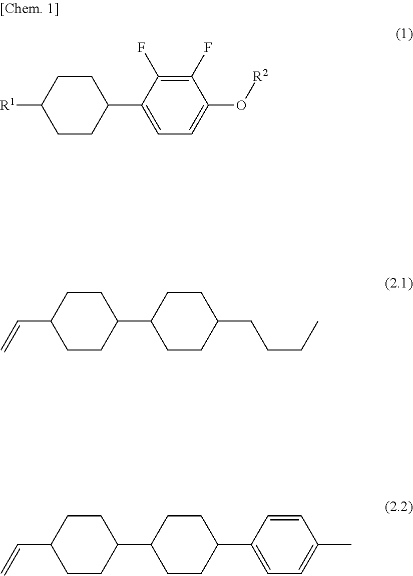

### TECHNICAL FIELD

The present invention relates to a liquid crystal composition, and a liquid crystal display element and a liquid crystal display that include the liquid crystal composition.

### BACKGROUND ART

Liquid crystal display elements have come to be used in watches, calculators, various measurement instruments, automobile panels, word processors, electronic organizers, printers, computers, televisions, clocks, advertising boards, and the like. Typical examples of the liquid crystal display mode include TN (twisted nematic) mode, STN (super twisted nematic) mode, and VA (vertical alignment) mode and IPS (in-plane switching) mode that use TFTs (thin film transistors). Liquid crystal compositions that are used in these liquid crystal display elements are required to be stable against external factors such as moisture, air, heat, and light, stay in a liquid crystal phase in a temperature range as wide as possible around room temperature, exhibit low viscosity, and operate at a low driving voltage. Such a liquid crystal composition is constituted by several to several tens of compounds in order to optimize dielectric anisotropy (Δ∈), refractive index anisotropy (Δn), and the like for individual display elements.

Vertical alignment mode displays use liquid crystal compositions having a negative Δ∈ and are widely used for liquid crystal TVs and the like. On the other hand, for all operation modes, there is a demand for low-voltage operation, high-speed response, and a wide operation temperature range. Specifically, there is a demand for Δ∈ that is positive and the absolute value of which is large, and for a low viscosity (η) and a high nematic phase-isotropic liquid phase transition temperature (Tₙᵢ). On the basis of predetermined Δn×d, which is the product of Δn and cell gap (d), Δn of the liquid crystal composition needs to be appropriately adjusted so as to be in a range in accordance with the cell gap. In addition, in the case where liquid crystal display elements are applied to televisions and the like, high-speed response is a priority. Accordingly, liquid crystal compositions having a low rotational viscosity (γ₁) are required.

In general, in order to constitute a liquid crystal composition having a low γ₁, a compound having a dialkylbicyclohexane skeleton has been used (refer to Patent Literature 1). However, although bicyclohexane compounds are advantageous in achieving a low γ₁, in general, they have a high vapor pressure: this tendency becomes strong particularly in compounds having short alkyl chains. In addition, Tₙᵢ tends to be low. Accordingly, alkylbicyclohexane compounds whose side chains have 7 or more carbon atoms in total are usually used. Thus, there have been no sufficient studies on such compounds having short side chains.

There is a known liquid crystal composition using a dialkylbicyclohexane compound having short side chains (refer to Patent Literature 2). This composition is adjusted so as to have well-balanced properties by using a large amount of a compound having a tricyclo structure and a negative dielectric anisotropy and by using a compound having a difluoroethylene skeleton. However, the difluoroethylene skeleton used in this composition has a problem of low stability against light. Accordingly, there has been a demand for the development of a liquid crystal composition that does not contain such compounds.

Meanwhile, as liquid crystal display elements are used in wider applications, the way of using the elements and the method of producing the elements have considerably changed. In order to adapt to such changes, optimization of characteristics other than known basic property values has come to be required. Specifically, for liquid crystal display elements using liquid crystal compositions, VA (vertical alignment) mode, IPS (in-plane switching) mode, and the like have come to be commonly used. Regarding the size of liquid crystal display elements, display elements having a very large size of 50 inches or more have come to be put into practical use and are being used. With the increase in substrate size, the main process of injecting a liquid crystal composition between substrates has changed from the conventional vacuum injection process to the one drop fill (ODF) process (refer to Patent Literature 3). Thus, a problem has arisen: dropping marks formed during dropping of liquid crystal compositions on substrates cause degradation of display quality. Here, the term “dropping marks” is defined as a phenomenon in which marks formed by dropping of liquid crystal compositions are seen as white marks during displaying in black.

In order to achieve high-speed response in control of the pretilt angle of liquid crystal material in liquid crystal display elements, PS liquid crystal display elements (polymer stabilized) and PSA liquid crystal display elements (polymer sustained alignment) were developed (refer to Patent Literature 4). As a result, the above-described problem has become more serious. In general, such display elements are characterized in that monomers are added to liquid crystal compositions and the monomers in the compositions are cured. On the other hand, regarding liquid crystal compositions for active matrix, a high voltage holding ratio needs to be maintained. Accordingly, use of compounds having ester bonds is limited and the number of usable compounds is small.

Monomers used for PSA liquid crystal display elements are mainly acrylates and, in general, acrylate compounds have ester bonds. In general, acrylate compounds are not used as liquid crystal compounds for active matrix (refer to Patent Literature 4). In the case where the content of acrylate compounds is high in liquid crystal compositions for active matrix, formation of dropping marks is induced; and, because of displaying failure, the yield of liquid crystal display elements becomes poor, which is problematic. In addition, when additives such as antioxidants and light absorbing agents are added to the liquid crystal compositions, the yield also becomes poor, which is problematic.

In order to suppress dropping marks, the following method is disclosed: a polymerizable compound mixed in a liquid crystal composition is polymerized to form a polymer layer in a liquid crystal layer, so that dropping marks, which are formed in relation to alignment control films, are suppressed (Patent Literature 5). However, in this method, a problem of burn-in during displaying is caused by the polymerizable compound added to the liquid crystal composition, and the effect of suppressing dropping marks is insufficient. Accordingly, there has been a demand for the development of a liquid crystal display element in which basic characteristics of a liquid crystal display element are maintained and burn-in and dropping marks tend not to occur.

### CITATION LIST

### Patent Literature

PTL 1: Japanese Unexamined Patent Application Publication (Translation of PCT Application) No. 2008-505235

PTL 2: Japanese Unexamined Patent Application Publication No. 2012-136623

PTL 3: Japanese Unexamined Patent Application Publication No. 6-235925

PTL 4: Japanese Unexamined Patent Application Publication No. 2002-357830

PTL 5: Japanese Unexamined Patent Application Publication No. 2006-58755

### SUMMARY OF INVENTION

### Technical Problem

An object of the present invention is to provide a liquid crystal composition that has good characteristics in terms of dielectric anisotropy (Δ∈), viscosity (η), the upper limit temperature of the nematic phase (Tₙᵢ), stability of the nematic phase at low temperatures (solubility), rotational viscosity (γ₁), and burn-in, that tends not to cause formation of dropping marks during production of a liquid crystal display element, and that allows stable discharging during the ODF step; and a liquid crystal display element and a liquid crystal display that include the liquid crystal composition.

### Solution to Problem

In order to address the above-described problems, the inventors of the present invention performed studies on various configurations of liquid crystal compositions optimal for production of liquid crystal display elements by the one drop fill process. The inventors have found that use of specific liquid crystal compounds mixed in a specific mixing ratio can suppress formation of dropping marks in liquid crystal display elements. Thus, the inventors have accomplished the present invention. Specifically, a first aspect of the present invention relates to the following liquid crystal compositions (i) to (iv).

(i) A liquid crystal composition having a negative dielectric anisotropy includes a dielectrically negative component (A) containing a compound represented by a general formula (1) below, and a component (B) that is a dielectrically neutral component containing at least one of compounds represented by a formula (2.1) and a formula (2.2) below,

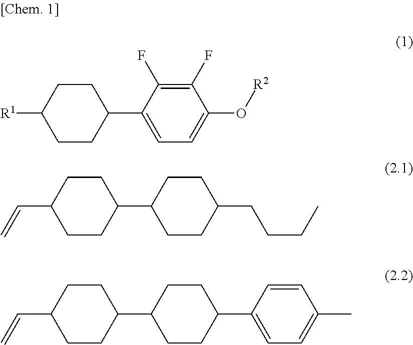

[where R¹ and R² each independently represent an alkyl group having 1 to 5 carbon atoms].
(ii) The liquid crystal composition according to (i) above, wherein the compound represented by the general formula (1) is a compound represented by a formula (1.1) below.

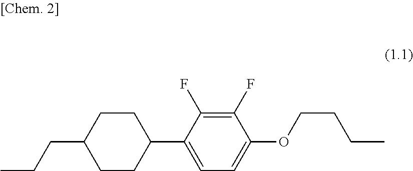

(iii) The liquid crystal composition according to (i) or (ii) above, wherein a content of the compound represented by the formula (2.2) relative to a total mass of the liquid crystal composition is 14% by mass or more.
(iv) The liquid crystal composition according to (ii) above, wherein a content of the compound represented by the formula (1.1) relative to a total mass of the liquid crystal composition is 23% by mass or more.

A second aspect of the present invention relates to a liquid crystal display element including the liquid crystal composition according to the first aspect.

A third aspect of the present invention relates to a liquid crystal display including the liquid crystal display element according to the second aspect.

### Advantageous Effects of Invention

A liquid crystal composition according to the present invention is good in terms of various characteristics such as dielectric anisotropy (Δ∈), viscosity (η), the upper limit temperature of the nematic phase (Tₙᵢ), stability of the nematic phase at low temperatures (solubility), and rotational viscosity (γ₁) and allows stable discharging during the ODF step during production of liquid crystal display elements.

A liquid crystal display element including a liquid crystal composition according to the present invention is excellent in terms of high-speed response, tends not to cause burn-in, and tends not to have dropping marks due to the ODF step during production. Accordingly, a liquid crystal composition according to the present invention is useful for display elements for liquid crystal TVs, monitors, and the like.

### BRIEF DESCRIPTION OF DRAWINGS

FIG. 1 is a schematic view illustrating an example of the structure of a liquid crystal display element according to a second aspect of the present invention.

FIG. 2 is a sectional view illustrating an example of the configuration of an inverted staggered thin film transistor.

### DESCRIPTION OF EMBODIMENTS

As described above, the detailed process of formation of dropping marks is not clear at present. However, it is highly probable that impurities in a liquid crystal compound (liquid crystal composition), an alignment-film interaction, a chromatographic phenomenon, and the like relate to formation of dropping marks. The presence or absence of impurities in a liquid crystal compound largely depends on the production process of the compound. In general, regarding the production methods of liquid crystal compounds, optimal processes and raw materials are studied for respective compounds. Even when a compound that is similar to a known compound, the compound being different from the known compound only in the number of side chains, is produced, the production process is not necessarily similar to or the same as the process of the known compound. Since liquid crystal compounds are produced by accurate production processes, the production cost is high among chemical products and there is a strong demand for an increase in the production efficiency. Thus, in order to use raw materials that are as inexpensive as possible, even when a similar compound that is different only in that the number of side chains differs by one is produced, there are cases where, instead of known raw materials, production from totally different raw materials is more efficient. Accordingly, production processes of liquid crystal technical products (liquid crystal compositions) may be different for respective technical products; and even when such processes are the same, different raw materials are often used. As a result, different technical products often contain different impurities. On the other hand, dropping marks may be formed even in the presence of a very small amount of impurities. Suppression of formation of dropping marks only by purification of technical products has limitation.

On the other hand, the production methods of commonly used liquid crystal technical products tend to become standardized for respective technical products after the production processes are established. Even nowadays, with improved analysis techniques, it is not easy to completely identify impurities. It is necessary to design liquid crystal compositions on the premise that respective technical products contain corresponding impurities.

The production steps of a liquid crystal display panel include a step of injecting liquid crystal into the panel. In general, this step is performed by the vacuum injection process or the ODF process. In the liquid crystal injection step, the liquid crystal composition is exposed to a reduced pressure. Liquid crystal compositions do not easily volatilize at room temperature and pressure. However, under a reduced pressure, depending on a compound used, the content of the compound, or combination thereof, the compound may volatilize. Volatilization of the low molecular weight components leads to a change in the composition of the liquid crystal composition, which is the direct cause of changes in the characteristics of the liquid crystal. In addition, the volatilized low molecular weight components may adhere to various parts of production apparatuses, so that the production apparatuses are contaminated, resulting in indirect changes in the characteristics. Such production contamination progresses as the number of the panel production lots increases. For example, the partial pressure of volatile substances in a reduced pressure step may change or volatilized components may enter the liquid crystal composition of later lots (lots produced later) to thereby cause changes in the characteristics. Such phenomena adversely affect the reliability of liquid crystal display elements. Accordingly, when necessary, the production apparatuses are washed. When the production apparatuses are washed, production cannot be performed during the washing period. Accordingly, as the number of times of washing increases, the production efficiency is decreased. In other words, by using a liquid crystal that tends not to volatilize, the number of times of washing of production apparatuses is decreased. Thus, the downtime of production apparatuses for washing is reduced, so that the production efficiency can be increased.

The inventors of the present invention performed studies on the relationship between impurities of a liquid crystal technical product and dropping marks. As a result, the inventors have empirically revealed that impurities in a liquid crystal composition include impurities that tend not to cause formation of dropping marks and impurities that tend to cause formation of dropping marks. Furthermore, the inventors have found the following finding: in order to suppress formation of dropping marks, use of a liquid crystal composition containing specific compounds in a specific mixing ratio is important.

Furthermore, the inventors performed thorough studies on the combination of components of a liquid crystal composition that has excellent characteristics and tends not to cause formation of dropping marks. As a result, the inventors have found a liquid crystal composition that tends not to volatilize and has a very low probability of causing apparatus contamination. Interestingly, the following phenomenon has also been found: in spite of a low molecular weight and nonpolar liquid crystal compound that itself tends to volatilize, in the state of a liquid crystal composition having a specific content of a specific polar compound, the probability of occurrence of apparatus contamination becomes very low.

Specifically, a liquid crystal composition according to the present invention is a composition that exhibits excellent characteristics in liquid crystal display panels, in particular, that tends not to cause formation of dropping marks, and that has a low probability of causing apparatus contamination. The following preferred embodiments have been found from the above-described standpoints.

Hereinafter, the present invention will be specifically described. However, the present invention is not limited to the descriptions.

Unless otherwise specified, “%” denotes % by mass below.

### <<Liquid Crystal Composition>>

A liquid crystal composition according to the first aspect of the present invention is a liquid crystal composition having a negative dielectric anisotropy (dielectric anisotropy) and contains a component (A) and a component (B). The dielectric anisotropy of the liquid crystal composition is −2 or less.

The component (A) is a dielectrically negative component containing a compound represented by a general formula (1) below. The “dielectrically negative component” denotes a “component having a dielectric anisotropy of −2 or less”.

The component (B) is a dielectrically neutral component containing at least one of compounds represented by a formula (2.1) and a formula (2.2) below. The “dielectrically neutral component” denotes “having a dielectric anisotropy of more than −2 and less than +2”.

The values of the dielectric anisotropy of the components and the dielectric anisotropy of the liquid crystal composition are measured in a standard manner at 25° C.

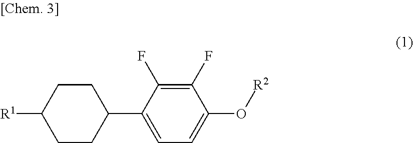

[where R¹ and R² each independently represent an alkyl group having 1 to 5 carbon atoms].

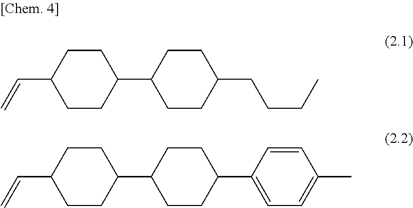

Compounds constituting the component (A) are dielectrically negative compounds. Each compound constituting the component (A) preferably has a dielectric anisotropy of −1 or less, preferably −1.5 or less, more preferably −2 or less, still more preferably −2.5 or less; and, in particular, the lower the dielectric anisotropy in the order of from −3.0 or less, −3.5 or less, −4.0 or less, −4.5 or less, to −5.0 or less, the more preferable it is. The lower limit of the dielectric anisotropy is not particularly limited; however, an example of the lower limit is about −10.0.

Compounds constituting the component (B) are dielectrically neutral compounds. Each compound constituting the component (B) preferably has a dielectric anisotropy of −2.0 to 2.0, more preferably −1.5 to 1.5, still more preferably −1.0 to 1.0.

The total content of the compound group represented by the general formula (1) in the liquid crystal composition is not particularly limited. In an embodiment of the present invention, the content is 5% to 60%. In another embodiment of the present invention, the content is 20% to 50%. In still another embodiment of the present invention, the content is 25% to 40%.

In the general formula (1), the alkyl group of R¹ is preferably a linear alkyl group. The number of carbon atoms of the alkyl group is preferably 2 to 5, more preferably 3 to 5, still more preferably 3 or 5.

In the general formula (1), the alkyl group of R² is preferably a linear alkyl group. The number of carbon atoms of the alkyl group is preferably 2 to 5, more preferably 2 to 4, still more preferably 2 or 4.

In the compound group represented by the general formula (1), particularly preferred are compounds represented by a formula (1.1) to a formula (1.3) below.

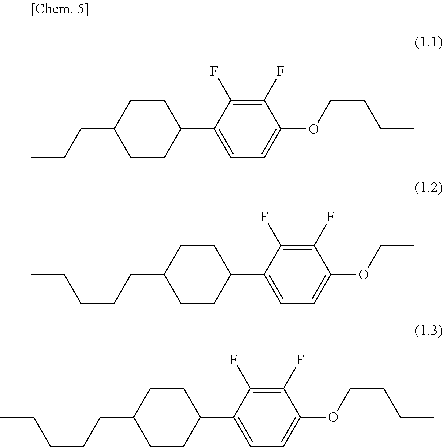

Hereafter, the compounds represented by the formula (1.1), the formula (1.2), the formula (1.3), the formula (2.1), and the formula (2.2) are respectively referred to as a compound (1.1), a compound (1.2), a compound (1.3), a compound (2.1), and a compound (2.2).

The content of the compound (1.1) in the liquid crystal composition is not particularly limited. In the case where the compound (1.1) is contained, the content of the compound (1.1) in the liquid crystal composition is preferably 23% or more relative to the total mass of the liquid crystal composition. In an embodiment of the present invention, the content is 5% to 50%. In another embodiment of the present invention, the content is 15% to 45%. In still another embodiment of the present invention, the content is 23% to 40%.

The content of the compound (1.2) in the liquid crystal composition is not particularly limited. In an embodiment of the present invention, the content is 3% to 30%. In another embodiment of the present invention, the content is 6% to 20%. In still another embodiment of the present invention, the content is 10% to 15%.

The content of the compound (1.3) in the liquid crystal composition is not particularly limited. In the case where the compound (1.3) is contained, the content of the compound (1.3) in the liquid crystal composition is preferably more than 16% relative to the total mass of the liquid crystal composition. In an embodiment of the present invention, the content is 1% to 40%. In another embodiment of the present invention, the content is 10% to 35%. In still another embodiment of the present invention, the content is 17% to 30%.

The content of the compound (2.1) in the liquid crystal composition is not particularly limited. In an embodiment of the present invention, the content is 1% to 4%. In another embodiment of the present invention, the content is 4% to 9%. In still another embodiment of the present invention, the content is 9% to 20%.

In another embodiment of the present invention, the content is 21% to 38% or 40% or more.

The content of the compound (2.2) in the liquid crystal composition is not particularly limited. In the case where the compound (2.2) is contained, the content of the compound (2.2) in the liquid crystal composition is preferably 14% or more relative to the total mass of the liquid crystal composition. In an embodiment of the present invention, the content is 1% to 50%. In another embodiment of the present invention, the content is 9% to 40%. In still another embodiment of the present invention, the content is 14% to 35%.

The total content of the compound (1.1), the compound (1.2), and the compound (1.3) in the liquid crystal composition is not particularly limited. In an embodiment of the present invention, the content is 5% to 60%. In another embodiment of the present invention, the content is 20% to 50%. In still another embodiment of the present invention, the content is 25% to 40%.

The total content of the compound group represented by the general formula (1) and the compound (2.1) in the liquid crystal composition is not particularly limited. In an embodiment of the present invention, the content is 10% to 70%. In another embodiment of the present invention, the content is 25% to 60%. In still another embodiment of the present invention, the content is 35% to 55%.

The total content of the compound group represented by the general formula (1) and the compound (2.2) in the liquid crystal composition is not particularly limited. In an embodiment of the present invention, the content is 10% to 75%. In another embodiment of the present invention, the content is 30% to 70%. In still another embodiment of the present invention, the content is 40% to 65%.

The total content of the compound (2.1) and the compound (2.2) in the liquid crystal composition is not particularly limited. In an embodiment of the present invention, the content is 1% to 40%. In another embodiment of the present invention, the content is 5% to 30%. In still another embodiment of the present invention, the content is 10% to 20%.

In the case where the compound (1.1) and the compound (2.1) are used in combination, regarding the content of each compound in the liquid crystal composition, for example, there are the following embodiments.

In an embodiment of the present invention, the content of the compound (1.1) is 8% to 16% and the content of the compound (2.1) is 16% to 24%.

In another embodiment of the present invention, the content of the compound (1.1) is 24% to 32% and the content of the compound (2.1) is 1% to 4%.

In still another embodiment of the present invention, the content of the compound (1.1) is 18% to 26% and the content of the compound (2.1) is 12% to 20%.

In the case where the compound (1.1) and the compound (2.2) are used in combination, regarding the content of each compound in the liquid crystal composition, for example, there are the following embodiments.

In an embodiment of the present invention, the content of the compound (1.1) is 15% to 35% and the content of the compound (2.2) is 10% to 20%.

In another embodiment of the present invention, the content of the compound (1.1) is 22% to 35% and the content of the compound (2.2) is 13% to 18%.

In still another embodiment of the present invention, the content of the compound (1.1) is 25% to 35% and the content of the compound (2.2) is 13% to 18%.

In the case where the compound (1.2) and the compound (2.1) are used in combination, regarding the content of each compound in the liquid crystal composition, for example, there are the following embodiments.

In an embodiment of the present invention, the content of the compound (1.2) is 6% to 14% and the content of the compound (2.1) is 1% to 9%.

In another embodiment of the present invention, the content of the compound (1.2) is 6% to 14% and the content of the compound (2.1) is 10% to 18%.

In still another embodiment of the present invention, the content of the compound (1.2) is 2% to 10% and the content of the compound (2.1) is 7% to 15%.

In the case where the compound (1.2) and the compound (2.2) are used in combination, regarding the content of each compound in the liquid crystal composition, for example, there are the following embodiments.

In an embodiment of the present invention, the content of the compound (1.2) is 7% to 15% and the content of the compound (2.2) is 10% to 18%.

In another embodiment of the present invention, the content of the compound (1.2) is 2% to 10% and the content of the compound (2.2) is 9% to 17%.

In still another embodiment of the present invention, the content of the compound (1.2) is 2% to 10% and the content of the compound (2.2) is 1% to 4%.

In the case where the compound (1.3) and the compound (2.1) are used in combination, regarding the content of each compound in the liquid crystal composition, for example, there are the following embodiments.

In an embodiment of the present invention, the content of the compound (1.3) is 6% to 14% and the content of the compound (2.1) is 1% to 9%.

In another embodiment of the present invention, the content of the compound (1.3) is 2% to 10% and the content of the compound (2.1) is 1% to 9%.

In still another embodiment of the present invention, the content of the compound (1.3) is 2% to 14% and the content of the compound (2.1) is 1% to 9%.

In the case where the compound (1.3) and the compound (2.2) are used in combination, regarding the content of each compound in the liquid crystal composition, for example, there are the following embodiments.

In an embodiment of the present invention, the content of the compound (1.3) is 13% to 21% and the content of the compound (2.2) is 6% to 14%.

In another embodiment of the present invention, the content of the compound (1.3) is 8% to 16% and the content of the compound (2.2) is 10% to 18%.

In still another embodiment of the present invention, the content of the compound (1.3) is 15% to 23% and the content of the compound (2.2) is 1% to 5%.

The component (A) may additionally contain a compound represented by a formula (a1) below.

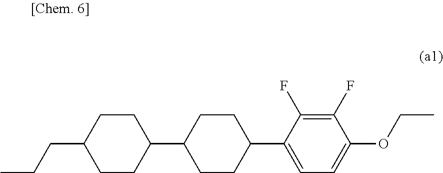 [SMILES: CCCC1CCC(C2CCC(c3ccc(OCC)c(F)c3F)CC2)CC1]

In the case where the compound represented by the formula (a1) is contained, its content in the liquid crystal composition is preferably 6% to 11%, more preferably 7% to 10%, still more preferably 8% to 9%.

The compound represented by the formula (a1) is preferably used in combination with the compound (1.1). In the case where this combination is used, the total content of the compound represented by the formula (a1) and the compound (1.1) in the liquid crystal composition is more preferably 30% to 50%. In the case where this combination is used, still more preferably, in the liquid crystal composition, the content of the compound (1.1) is 22% to 40% and the content of the compound represented by the formula (a1) is 8% to 20%. In the case where the compound represented by the formula (a1) is used in combination with the compound (1.1), in particular, these compounds are preferably used in combination with the compound (2.1). In such a case where the compound (2.1) is combined, the content of the compound (2.1) in the liquid crystal composition is most preferably 15% to 20%.

In the case where the compound represented by the formula (a1) is used in combination with the compound (2.2), the total content of the compound represented by the formula (a1) and the compound (2.2) in the liquid crystal composition is preferably 15% to 30%. In the case where this combination is used, more preferably, in the liquid crystal composition, the content of the compound represented by the formula (a1) is 6% to 12% and the content of the compound (2.2) is 8% to 18%. In the case where the compound represented by the formula (a1) is used in combination with the compound (2.2), still more preferably, these compounds are used in combination with a compound represented by a formula (b7). In such a case where the compound represented by the formula (b7) is combined, in particular, the content of the compound represented by the formula (b7) in the liquid crystal composition is preferably 6% to 14%.

The component (A) may additionally contain a compound represented by a formula (a2) below.

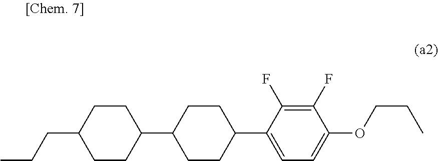 [SMILES: CCCOc1ccc(C2CCC(C3CCC(CCC)CC3)CC2)c(F)c1F]

In the case where the compound represented by the formula (a2) is contained, regarding its content in the liquid crystal composition, for example, there are the following embodiments.

In an embodiment of the present invention, the content is 3% to 15%. In another embodiment of the present invention, the content is 4% to 10%. In still another embodiment of the present invention, the content is 6% to 8%.

The component (A) may additionally contain a compound represented by a formula (a3) below.

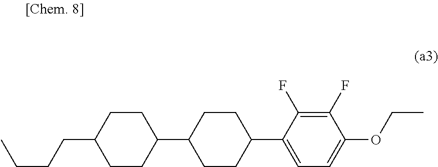 [SMILES: CCCCC1CCC(C2CCC(c3ccc(OCC)c(F)c3F)CC2)CC1]

In the case where the compound represented by the formula (a3) is contained, regarding its content in the liquid crystal composition, for example, there are the following embodiments.

In an embodiment of the present invention, the content is 1% to 10%. In another embodiment of the present invention, the content is 1% to 8%. In still another embodiment of the present invention, the content is 4% to 8%.

The component (A) may additionally contain a compound represented by a formula (a4) below.

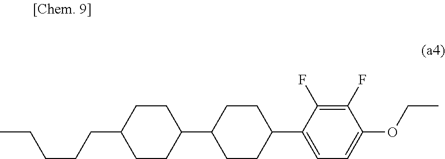 [SMILES: CCCCCC1CCC(C2CCC(c3ccc(OCC)c(F)c3F)CC2)CC1]

In the case where the compound represented by the formula (a4) is contained, regarding its content in the liquid crystal composition, for example, there are the following embodiments.

In an embodiment of the present invention, the content is 1% to 12%. In another embodiment of the present invention, the content is 2% to 6%. In still another embodiment of the present invention, the content is 6% to 12%.

The component (A) may additionally contain a compound represented by a formula (a5) below.

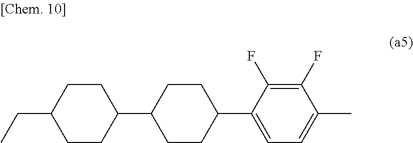 [SMILES: CCC1CCC(C2CCC(c3ccc(C)c(F)c3F)CC2)CC1]

In the case where the compound represented by the formula (a5) is contained, regarding its content in the liquid crystal composition, for example, there are the following embodiments.

In an embodiment of the present invention, the content is 2% to 12%. In another embodiment of the present invention, the content is 3% to 10%. In still another embodiment of the present invention, the content is 6% to 9%.

The component (A) may additionally contain a compound represented by a formula (a6) below.

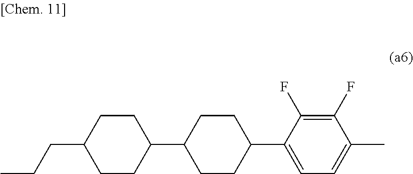 [SMILES: CCCC1CCC(C2CCC(c3ccc(C)c(F)c3F)CC2)CC1]

In the case where the compound represented by the formula (a6) is contained, regarding its content in the liquid crystal composition, for example, there are the following embodiments.

In an embodiment of the present invention, the content is 2% to 12%. In another embodiment of the present invention, the content is 3% to 10%. In still another embodiment of the present invention, the content is 6% to 9%.

The component (A) may additionally contain a compound represented by a formula (a7) below.

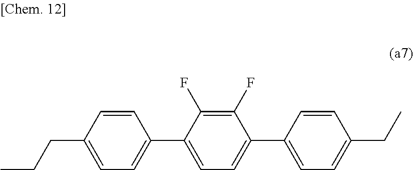 [SMILES: CCCc1ccc(-c2ccc(-c3ccc(CC)cc3)c(F)c2F)cc1]

In the case where the compound represented by the formula (a7) is contained, its content in the liquid crystal composition is preferably 2% to 25%, more preferably 7% to 25%, still more preferably 10% to 20%, particularly preferably 12% to 18%.

The compound represented by the formula (a7) is preferably used in combination with the compound represented by the formula (a1). In the case where this combination is used, the total content of the compound represented by the formula (a7) and the compound represented by the formula (a1) in the liquid crystal composition is more preferably 15% to 25%. In the case where this combination is used, still more preferably, in the liquid crystal composition, the content of the compound represented by the formula (a7) is 12% to 20% and the content of the compound represented by the formula (a1) is 4% to 12%. In the case where the compound represented by the formula (a7) is used in combination with the compound represented by the formula (a1), in particular, these compounds are preferably used in combination with a compound represented by a formula (a8). In such a case where the compound represented by the formula (a8) is combined, the content of the compound represented by the formula (a8) in the liquid crystal composition is most preferably 1% to 3%.

The component (A) may additionally contain a compound represented by a formula (a8) below.

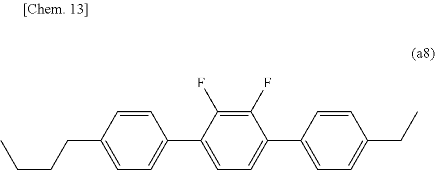 [SMILES: CCCCc1ccc(-c2ccc(-c3ccc(CC)cc3)c(F)c2F)cc1]

In the case where the compound represented by the formula (a8) is contained, regarding its content in the liquid crystal composition, for example, there are the following embodiments.

In an embodiment of the present invention, the content is 1% to 10%. In another embodiment of the present invention, the content is 1% to 7%. In still another embodiment of the present invention, the content is 1% to 3%.

The component (A) may additionally contain a compound represented by a formula (a9) below.

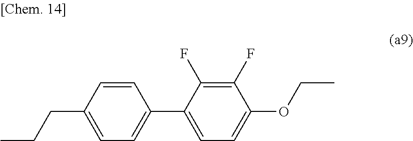 [SMILES: CCCc1ccc(-c2ccc(OCC)c(F)c2F)cc1]

In the case where the compound represented by the formula (a9) is contained, the content of the compound in the liquid crystal composition is not particularly limited and may be, for example, 1% to 18%.

The component (A) may additionally contain a compound represented by a formula (a10) below.

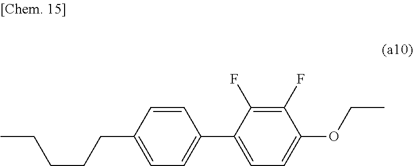 [SMILES: CCCCCc1ccc(-c2ccc(OCC)c(F)c2F)cc1]

In the case where the compound represented by the formula (a10) is contained, the content of the compound in the liquid crystal composition is not particularly limited and may be, for example, 1% to 16%.

The component (A) may additionally contain a compound represented by a formula (a11) below.

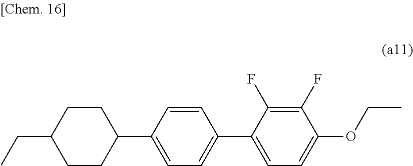 [SMILES: CCOc1ccc(-c2ccc(C3CCC(CC)CC3)cc2)c(F)c1F]

In the case where the compound represented by the formula (a11) is contained, regarding its content in the liquid crystal composition, for example, there are the following embodiments.

In an embodiment of the present invention, the content is 4% to 15%. In another embodiment of the present invention, the content is 7% to 12%. In still another embodiment of the present invention, the content is 9% to 11%.

The component (A) may additionally contain a compound represented by a formula (a12) below.

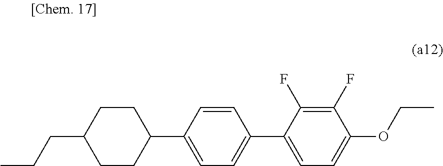 [SMILES: CCCC1CCC(c2ccc(-c3ccc(OCC)c(F)c3F)cc2)CC1]

In the case where the compound represented by the formula (a12) is contained, regarding its content in the liquid crystal composition, for example, there are the following embodiments.

In an embodiment of the present invention, the content is 3% to 18%. In another embodiment of the present invention, the content is 7% to 13%. In still another embodiment of the present invention, the content is 9% to 11%.

The component (A) may additionally contain a compound represented by a formula (a13) below.

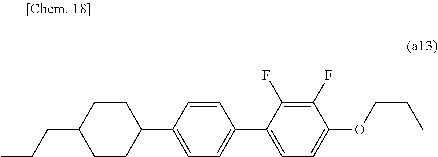 [SMILES: CCCOc1ccc(-c2ccc(C3CCC(CCC)CC3)cc2)c(F)c1F]

In the case where the compound represented by the formula (a13) is contained, its content in the liquid crystal composition is preferably 1% to 12%, more preferably 2% to 10%, still more preferably 4% to 8%.

The component (A) may additionally contain a compound represented by a formula (a14) below.

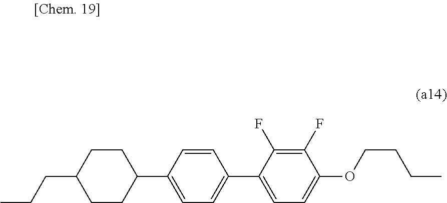 [SMILES: CCCCOc1ccc(-c2ccc(C3CCC(CCC)CC3)cc2)c(F)c1F]

In the case where the compound represented by the formula (a14) is contained, its content in the liquid crystal composition is preferably 2% to 14%, more preferably 4% to 12%, still more preferably 6% to 10%.

The component (A) may additionally contain a compound represented by a formula (a15) below.

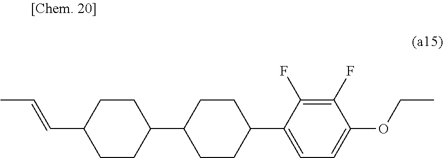 [SMILES: C/C=C/C1CCC(C2CCC(c3ccc(OCC)c(F)c3F)CC2)CC1]

In the case where the compound represented by the formula (a15) is contained, regarding its content in the liquid crystal composition, for example, there are the following embodiments.

In an embodiment of the present invention, the content of the compound represented by the formula (a15) is preferably 2% to 5%, more preferably 3% to 5%, still more preferably 4% to 5%.

In another embodiment of the present invention, the content of the compound represented by the formula (a15) is preferably 5% to 15%, more preferably 7% to 13%, still more preferably 8% to 11%.

The compound represented by the formula (a15) is preferably used in combination with at least one compound among the compound (1.1), the compound (2.1), and the compound (2.2); more preferably used in combination with the compound (1.1) and the compound (2.1) or in combination with the compound (1.1) and the compound (2.2); and still more preferably used in combination with three compounds of the compound (1.1), the compound (2.1), and the compound (2.2).

In the case where the four compounds of the compound represented by the formula (a15), the compound (1.1), the compound (2.1), and the compound (2.2) are used in combination, the content of the compound (2.1) in the liquid crystal composition is preferably less than 5%, more preferably 1% to 4%.

In the case where the four compounds of the compound represented by the formula (a15), the compound (1.1), the compound (2.1), and the compound (2.2) are used in combination, the content of the compound (2.2) in the liquid crystal composition is preferably more than 12%, more preferably 13% to 20%.

In the case where the four compounds of the compound represented by the formula (a15), the compound (1.1), the compound (2.1), and the compound (2.2) are used in combination, the content of the compound represented by the formula (a15) in the liquid crystal composition is preferably less than 5%, more preferably 1% to 4%.

The compound represented by the formula (a15) is preferably used in combination with a compound represented by a formula (a16) described below. In this case, the content of these compounds in the liquid crystal composition is preferably 2% to 26%, more preferably 6% to 22%, still more preferably 10% to 18%.

The component (A) may additionally contain a compound represented by a formula (a16) below.

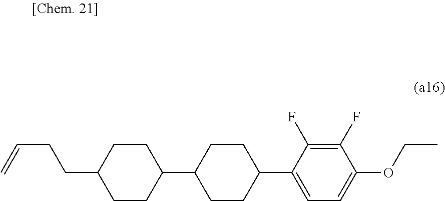 [SMILES: C=CCCC1CCC(C2CCC(c3ccc(OCC)c(F)c3F)CC2)CC1]

In the case where the compound represented by the formula (a16) is contained, regarding its content in the liquid crystal composition, for example, there are the following embodiments.

In an embodiment of the present invention, the content of the compound represented by the formula (a16) is preferably 2% to 5%, more preferably 3% to 5%, still more preferably 4% to 5%.

In another embodiment of the present invention, the content of the compound represented by the formula (a16) is preferably 5% to 15%, more preferably 7% to 13%, still more preferably 9% to 11%.

The compound represented by the formula (a16) is preferably used in combination with at least one compound among the compound (1.1), the compound (2.1), and the compound (2.2); more preferably used in combination with the compound (1.1) and the compound (2.1) or in combination with the compound (1.1) and the compound (2.2); and still more preferably used in combination with three compounds of the compound (1.1), the compound (2.1), and the compound (2.2).

In the case where the four compounds of the compound represented by the formula (a16), the compound (1.1), the compound (2.1), and the compound (2.2) are used in combination, the content of the compound (2.1) in the liquid crystal composition is preferably less than 5%, more preferably 1% to 4%.

In the case where the four compounds of the compound represented by the formula (a16), the compound (1.1), the compound (2.1), and the compound (2.2) are used in combination, the content of the compound (2.2) in the liquid crystal composition is preferably more than 12%, more preferably 13% to 20%.

In the case where the four compounds of the compound represented by the formula (a16), the compound (1.1), the compound (2.1), and the compound (2.2) are used in combination, the content of the compound represented by the formula (a16) in the liquid crystal composition is preferably more than 8%, more preferably 9% to 20%.

The compound represented by the formula (a16) is preferably used in combination with the compound represented by the formula (a15). In this case, the content of these compounds in the liquid crystal composition is preferably 2% to 26%, more preferably 6% to 22%, still more preferably 10% to 18%.

The component (B) may additionally contain a compound represented by a formula (b1) below.

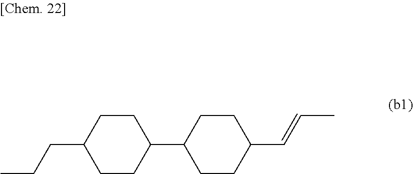 [SMILES: C/C=C/C1CCC(C2CCC(CCC)CC2)CC1]

In the case where the compound represented by the formula (b1) is contained, regarding its content in the liquid crystal composition, for example, there are the following embodiments.

In an embodiment of the present invention, the content is 2% to 18%. In another embodiment of the present invention, the content is 5% to 12%. In still another embodiment of the present invention, the content is 8% to 12%.

The component (B) may additionally contain a compound represented by a formula (b2) below.

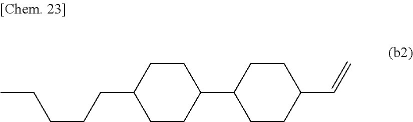 [SMILES: C=CC1CCC(C2CCC(CCCCC)CC2)CC1]

In the case where the compound represented by the formula (b2) is contained, its content in the liquid crystal composition is preferably 5% to 18%, more preferably 10% to 16%, still more preferably 13% to 16%.

The component (B) may additionally contain a compound represented by a formula (b3) below.

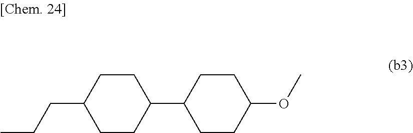 [SMILES: CCCC1CCC(C2CCC(OC)CC2)CC1]

In the case where the compound represented by the formula (b3) is contained, its content in the liquid crystal composition is preferably 1% to 25%, more preferably 5% to 20%, still more preferably 8% to 15%.

The component (B) may additionally contain a compound represented by a formula (b4) below.

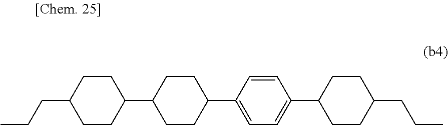 [SMILES: CCCC1CCC(c2ccc(C3CCC(C4CCC(CCC)CC4)CC3)cc2)CC1]

In the case where the compound represented by the formula (b4) is contained, its content in the liquid crystal composition is preferably 1% to 15%, more preferably 1% to 10%, still more preferably 1% to 5%.

The component (B) may additionally contain a compound represented by a formula (b5) below.

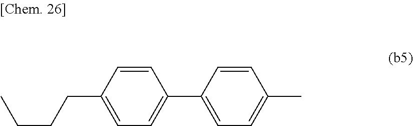 [SMILES: CCCCc1ccc(-c2ccc(C)cc2)cc1]

In the case where the compound represented by the formula (b5) is contained, its content in the liquid crystal composition is preferably 1% to 25%, more preferably 3% to 20%, still more preferably 5% to 10%.

The component (B) may additionally contain a compound represented by a formula (b6) below.

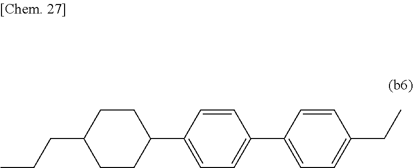 [SMILES: CCCC1CCC(c2ccc(-c3ccc(CC)cc3)cc2)CC1]

In the case where the compound represented by the formula (b6) is contained, its content in the liquid crystal composition is preferably 1% to 25%, more preferably 3% to 20%, still more preferably 5% to 15%.

The component (A) may additionally contain a compound represented by a formula (b7) below.

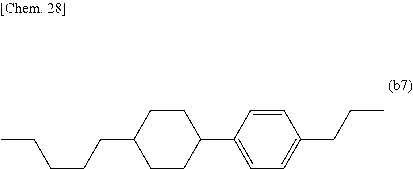 [SMILES: CCCCCC1CCC(c2ccc(CCC)cc2)CC1]

In the case where the compound represented by the formula (b7) is contained, its content in the liquid crystal composition is preferably 1% to 25%, more preferably 6% to 15%, still more preferably 8% to 12%.

The component (A) may additionally contain a compound represented by a formula (b8) below.

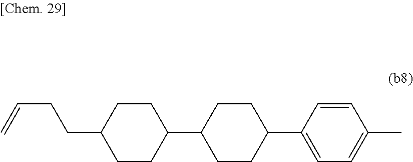 [SMILES: C=CCCC1CCC(C2CCC(c3ccc(C)cc3)CC2)CC1]

In the case where the compound represented by the formula (b8) is contained, its content in the liquid crystal composition is preferably 5% to 25%, more preferably 10% to 20%, still more preferably 12% to 17%.

The compound represented by the formula (b8) is preferably used in combination with the compound (1.3). In the case where this combination is used, the total content of the compound represented by the formula (b8) and the compound (1.3) in the liquid crystal composition is more preferably 30% to 50%. In the case where this combination is used, still more preferably, in the liquid crystal composition, the content of the compound (1.3) is 18% to 30% and the content of the compound represented by the formula (b8) is 12% to 20%. In the case where the compound represented by the formula (b8) is used in combination with the compound (1.3), in particular, these compounds are preferably used in combination with the compound represented by the formula (a4). In such a case where the compound represented by the formula (a4) is combined, the content of the compound represented by the formula (a4) in the liquid crystal composition is most preferably 1% to 5%.

The component (B) may additionally contain a compound represented by a formula (b9) below.

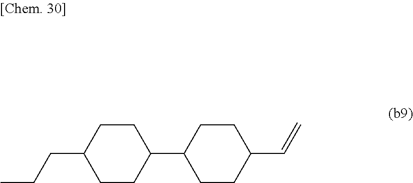 [SMILES: C=CC1CCC(C2CCC(CCC)CC2)CC1]

In the case where the compound represented by the formula (b9) is contained, its content in the liquid crystal composition is preferably 1% to 25%, more preferably 5% to 18%, still more preferably 8% to 13%.

In the liquid crystal composition, the content of compounds having 2 or more fluorine atoms, specifically, the compound group represented by the general formula (1) and the compounds represented by the formulae (a1) to (a16) are not particularly limited. In an embodiment of the present invention, the content is 50% to 95%. In another embodiment of the present invention, the content is 60% to 85%. In still another embodiment of the present invention, the content is 65% to 80%.

### <<Mixing Ratios of Component (A) and Component (B)>>

In the liquid crystal composition, the content ratios (mixing ratios) of the dielectrically negative component (A) and the dielectrically neutral component (B) are not particularly limited as long as the liquid crystal composition has a negative dielectric anisotropy; however, the content of the component (A) is preferably higher than that of the component (B).

Specifically, in the liquid crystal composition, the content of the component (A) having a negative dielectric anisotropy is preferably 50% or more, more preferably 60% to 85%, still more preferably 65% to 80%.

### <<Dielectric Anisotropy (Δ∈)>>

The dielectric anisotropy (Δ∈) of a liquid crystal composition according to the present invention at 25° C. is preferably −2.0 to −8.5, more preferably −3.0 to −7.5, still more preferably −3.5 to −6.0. More specifically, in the case where the response speed is a priority, the dielectric anisotropy (Δ∈) is preferably −2.6 to −4.0; and, in the case where the driving voltage is a priority, the dielectric anisotropy (Δ∈) is preferably −3.7 to −7.5.

<<Refractive Index Anisotropy (Δn)>>

The refractive index anisotropy (Δn) of a liquid crystal composition according to the present invention at 25° C. is preferably 0.08 to 0.13, more preferably 0.085 to 0.125, still more preferably 0.09 to 0.12. More specifically, in the case where the cell gap is small, the refractive index anisotropy (Δn) is preferably 0.10 to 0.12; and, in the case where the cell gap is large, the refractive index anisotropy (Δn) is preferably 0.08 to 0.10.

### <<Rotational Viscosity (γ₁)>>

The rotational viscosity (γ₁) of a liquid crystal composition according to the present invention at 25° C. is preferably 290 mPa·s or less, more preferably 260 mPa·s or less, still more preferably 230 mPa·s or less, particularly preferably 200 mPa·s or less.

In a liquid crystal composition according to the present invention, a function Z of rotational viscosity and refractive index anisotropy preferably represents a specific value.

Z=γ1/Δn² [Formula 1]

(where γ₁ represents rotational viscosity and Δn represents refractive index anisotropy.)

Z is preferably 32000 or less, more preferably 22000 or less, still more preferably 19000 or less.

### <<Viscosity (η)>>

The viscosity (η) of a liquid crystal composition according to the present invention at 20° C. is preferably 40 mPa·s or less, more preferably 35 mPa·s or less, still more preferably 32 mPa·s or less, particularly preferably 30 mPa·s or less.

In the case where a liquid crystal composition according to the present invention is used for an active matrix display element, the resistivity of the liquid crystal composition is preferably 10¹¹ (Ω·m) or more, more preferably 10¹² (Ω·m) or more, still more preferably 10¹³ (Ω·m) or more, particularly preferably 10¹⁴ (Ω·m) or more.

### <<Another Component: Component (C)>>

A liquid crystal composition according to the present invention may contain a component (C) that is not the component (A) or the component (B). The content of the component (C) in the liquid crystal composition is not particularly limited and is preferably 20% or less, preferably 1% to 10%, more preferably 1% to 6%.

As the component (C), a compound having a dielectric anisotropy of “+2 or more”, which is a positive dielectric anisotropy, may be contained. For example, a compound represented by a formula (c1) below may be contained.

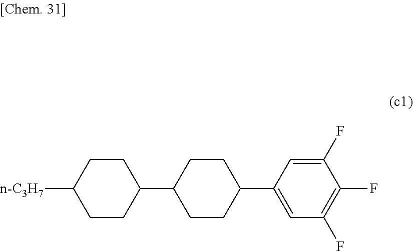

In the case where the compound represented by the formula (c1) is contained, its content in the liquid crystal composition is preferably 1% to 20%, more preferably 2% to 10%, still more preferably 3% to 7%.

A liquid crystal composition according to the present invention may contain, in addition to the above-described compounds, for example, depending on the application, standard nematic liquid crystal, smectic liquid crystal, cholesteric liquid crystal, an antioxidant, an ultraviolet absorber, or a polymerizable monomer.

The polymerizable monomer is preferably a bifunctional monomer represented by a general formula (VI) below.

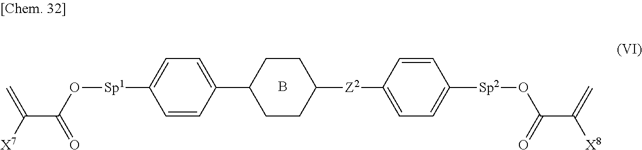

(where X⁷ and X⁸ each independently represent a hydrogen atom or a methyl group; Sp¹ and Sp² each independently represent a single bond, an alkylene group having 1 to 8 carbon atoms, or —O—(CH₂)ₛ—
(where s represents an integer of 2 to 7 and the oxygen atom is bonded to the aromatic ring);

Z² represents —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (where Y¹ and Y² each independently represent a fluorine atom or a hydrogen atom), —C≡C—, or a single bond;

B represents a 1,4-phenylene group, a trans-1,4-cyclohexylene group, or a single bond; and, in all the 1,4-phenylene groups in the formula, any hydrogen atoms may be replaced by fluorine atoms.)

Preferred are diacrylate derivatives in which both of X⁷ and X⁸ represent hydrogen atoms, dimethacrylate derivatives in which both of X⁷ and X⁸ represent methyl groups, and compounds in which one of X⁷ and X⁸ represents a hydrogen atom and the other one of X⁷ and X⁸ represents a methyl group. Among these compounds, diacrylate derivatives have the highest rate of polymerization, dimethacrylate derivatives have a low rate of polymerization, and asymmetrical compounds have an intermediate rate of polymerization. Depending on the application, a preferred embodiment can be used. In PSA display elements, dimethacrylate derivatives are particularly preferred.

Sp¹ and Sp² each independently represent a single bond, an alkylene group having 1 to 8 carbon atoms, or —O—(CH₂)ₛ—. In PSA display elements, at least one of Sp¹ and Sp² preferably represents a single bond; preferred are compounds in which both of Sp¹ and Sp² represent a single bond or configurations in which one of Sp¹ and Sp² represents a single bond and the other represents an alkylene group having 1 to 8 carbon atoms or —O—(CH₂)ₛ—. In this case, preferred is a 1-4 alkyl group and s preferably represents 1 to 4.

Z² preferably represents —OCH₂—, —CH₂O—, —COO—, —OCO—, —CF₂O—, —OCF₂—, —CH₂CH₂—, —CF₂CF₂—, or a single bond, more preferably —COO—, —OCO—, or a single bond, particularly preferably a single bond.

B represents a 1,4-phenylene group in which any hydrogen atoms may be replaced by fluorine atoms, a trans-1,4-cyclohexylene group, or a single bond. B preferably represents a 1,4-phenylene group or a single bond. In the case where B represents a cyclic structure other than a single bond, Z² preferably represents a bond group other than a single bond. In the case where B represents a single bond, Z² preferably represents a single bond.

From the standpoints of the foregoing, in the general formula (VI), specifically, the cyclic structure between Sp¹ and Sp² preferably represents the following structures.

In the general formula (VI), in the case where B represents a single bond and the cyclic structure is constituted by two rings, the cyclic structure preferably represents a formula (VIa-1) to a formula (VIa-5) below, more preferably represents the formula (VIa-1) to the formula (VIa-3), particularly preferably represents the formula (VIa-1).

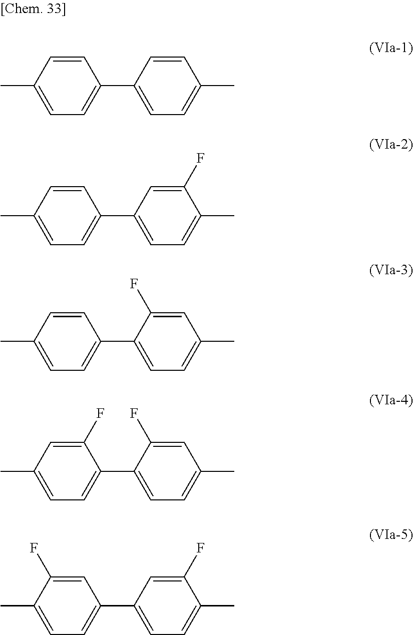

(where both ends are bonded to Sp¹ and Sp².)

Polymerizable compounds having such skeletons are polymerized to provide an anchoring strength optimal for PSA liquid crystal display elements, so that a good alignment state is achieved. Therefore, unevenness in displaying is suppressed or completely prevented.

Accordingly, regarding the polymerizable monomer, particularly preferred are formulae (VI-1) to (VI-4) below and, of these, most preferred is the formula (VI-2) below.

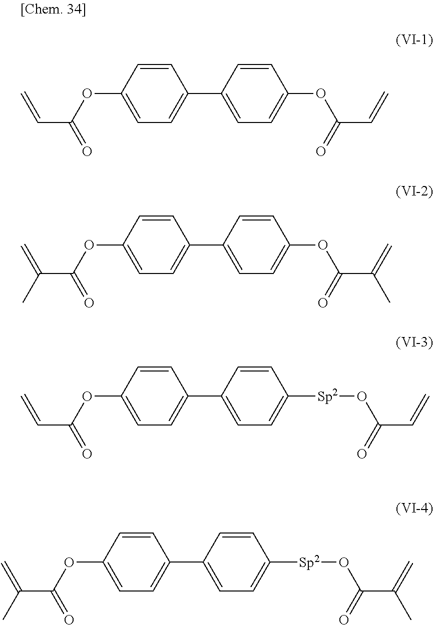

(where Sp² represents an alkylene group having 2 to 5 carbon atoms.)

In the case where a bifunctional monomer represented by the general formula (VI) is used as the polymerizable monomer, the content of the bifunctional monomer in the liquid crystal composition is preferably 2% or less, more preferably 1.5% or less, still more preferably 1% or less, particularly preferably 0.5% or less, most preferably 0.4% or less. In the case of 2% or less, the formation of dropping marks can be reduced.

In a case where such a monomer is added to a liquid crystal composition according to the present invention, polymerization proceeds even in the absence of a polymerization initiator, but a polymerization initiator may be contained to facilitate the polymerization. Examples of the polymerization initiator include benzoin ethers, benzophenones, acetophenones, benzylketals, and acylphosphine oxides. In order to enhance storage stability, a stabilizer may be added. Examples of a usable stabilizer include hydroquinones, hydroquinone monoalkyl ethers, tert-butylcatechols, pyrogallols, thiophenols, nitro compounds, β-naphthylamines, β-naphthols, and nitroso compounds.

A liquid crystal composition containing a polymerizable compound according to the present invention is useful for liquid crystal display elements, in particular, useful for active-matrix-driving liquid crystal display elements and can be used for PSA mode, PSVA mode, VA mode, IPS mode, or ECB mode liquid crystal display elements.

A liquid crystal composition containing a polymerizable compound according to the present invention is provided with a liquid crystal alignment capability by polymerizing the polymerizable compound therein through irradiation with ultraviolet rays and is used for liquid crystal display elements that control the amount of transmitted light by using the birefringence of the liquid crystal composition. The liquid crystal composition is useful for liquid crystal display elements such as an AM-LCD (active matrix liquid crystal display element), a TN (nematic liquid crystal display element), an STN-LCD (super-twisted nematic liquid crystal display element), an OCB-LCD, and an IPS-LCD (in-plane switching liquid crystal display element). The liquid crystal composition is particularly useful for AM-LCDs and can be used for transmission or reflection-type liquid crystal display elements.

Two substrates of a liquid crystal cell used for a liquid crystal display element may be formed of a flexible and transparent material such as glass or plastic. One of the substrates may be formed of an opaque material such as silicone. A transparent substrate having a transparent electrode layer may be obtained by, for example, sputtering with indium tin oxide (ITO) on a transparent substrate such as a glass plate.

These substrates are disposed so as to oppose each other with the transparent electrode layer therebetween. At this time, a spacer may be used to adjust the gap width between the substrates. This adjustment is preferably performed such that the resultant light control layer has a thickness of 1 to 100 μm, more preferably 1.5 to 10 μm. In the case where a polarizing plate is used, the product of the refractive index anisotropy Δn of liquid crystal and the cell gap d is preferably adjusted such that the contrast is maximized. In the case where two polarizing plates are used, the polarization axis of each polarizing plate may be adjusted so as to provide a good viewing angle and good contrast. Furthermore, a phase difference film for increasing the viewing angle may also be used. The spacer may be, for example, glass particles, plastic particles, alumina particles, or a photoresist material. After that, a sealing agent such as an epoxy thermosetting composition is disposed on the substrates by screen printing such that a liquid crystal inlet is formed. The substrates are bonded together and heated to thereby thermally cure the sealing agent.

A process for sandwiching a polymerizable-compound-containing liquid crystal composition between two substrates may be, for example, a standard vacuum injection process or an ODF process. In the vacuum injection process, dropping marks are not formed; however, injection marks are disadvantageously left. The present invention can be more suitably applied to display elements that are produced by the ODF process.

Regarding a process of polymerizing the polymerizable compound, a process allowing an appropriate rate of polymerization is desirable to achieve good liquid crystal alignment performance. Specifically, preferred is a polymerization process of applying an active energy ray, such as an ultraviolet ray or an electron beam, alone, or applying active energy rays in combination or in sequence. In the case where an ultraviolet ray is used, a polarized light source may be used or a non-polarized light source may be used. In the case where polymerization is caused in a polymerizable-compound-containing liquid crystal composition sandwiched between two substrates, at least a substrate to be irradiated needs to have appropriate transparency to the active energy ray. The following process may be used: polymerization is caused in predetermined regions alone by using a mask during application of light; after that, conditions in terms of an electric field, a magnetic field, temperature, or the like are changed so that the alignment state of unpolymerized regions is changed; and an active energy ray is further applied to cause polymerization. In particular, in the case of exposure to ultraviolet rays, exposure to ultraviolet rays is preferably performed while an alternating electric field is applied to the polymerizable-compound-containing liquid crystal composition. Regarding the applied alternating electric field, the alternating current preferably has a frequency of 10 Hz to 10 kHz, more preferably, a frequency of 60 Hz to 10 kHz; and the voltage is selected depending on the desired pretilt angle of the liquid crystal display element. That is, the applied voltage can be used to control the pretilt angle of the liquid crystal display element. In a liquid crystal display element employing the MVA mode, the pretilt angle is preferably controlled in the range of 80° to 89.9° from the viewpoint of alignment stability and contrast.

The temperature during irradiation is preferably within such a temperature range that the liquid crystal state of a liquid crystal composition according to the present invention is maintained. Polymerization is preferably caused at about room temperature, that is, typically 15° C. to 35° C. A lamp that generates ultraviolet rays may be a metal halide lamp, a high-pressure mercury-vapor lamp, an ultra-high-pressure mercury-vapor lamp, or the like. The wavelength of an ultraviolet ray applied is preferably in a wavelength region that does not correspond to the absorption wavelength region of the liquid crystal composition; and, if necessary, an ultraviolet ray is preferably filtered and used. The intensity of the ultraviolet ray applied is preferably 0.1 mW/cm² to 100 W/cm², more preferably 2 mW/cm² to 50 W/cm². The amount of energy of the ultraviolet ray applied can be appropriately adjusted and is preferably 10 mJ/cm² to 500 J/cm², more preferably 100 mJ/cm² to 200 J/cm². During application of the ultraviolet ray, the intensity thereof may be varied. The time for applying the ultraviolet ray is appropriately selected depending on the intensity of the applied ultraviolet ray and is preferably 10 seconds to 3600 seconds, more preferably 10 seconds to 600 seconds.

### <<Liquid Crystal Display Element>>

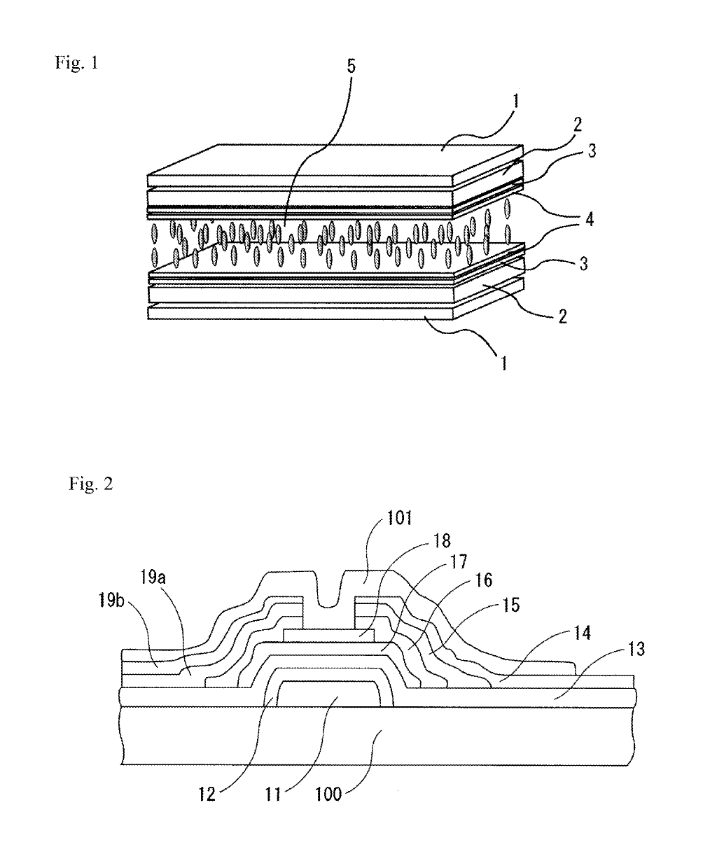

A liquid crystal display element according to a second aspect of the present invention preferably has the following configuration: as illustrated in FIG. 1, the liquid crystal display element includes a first substrate equipped with a common electrode formed of a transparent conductive material, a second substrate equipped with pixel electrodes formed of a transparent conductive material and thin film transistors that control pixel electrodes disposed for respective pixels, and a liquid crystal composition sandwiched between the first substrate and the second substrate. As this liquid crystal composition, a liquid crystal composition according to the first aspect is used. In the liquid crystal display element, liquid crystal molecules under application of no voltage are aligned so as to be substantially perpendicular to the substrates.

As described above, the formation of dropping marks is significantly influenced by the types and combination of liquid crystal compounds constituting the injected liquid crystal material (liquid crystal composition). Furthermore, the types and combination of members constituting the display element sometimes also influence the formation of dropping marks. In particular, members separating a color filter and a thin film transistor formed in a liquid crystal display element from a liquid crystal composition are only thin members such as an alignment film and a transparent electrode. Accordingly, the color filter and the thin film transistor may affect the liquid crystal composition to thereby cause formation of dropping marks.

In particular, when a liquid crystal display element has an inverted staggered thin film transistor, the drain electrode is formed so as to cover the gate electrode. Accordingly, the area of such a thin film transistor tends to increase. Such a drain electrode is formed of a metal material such as copper, aluminum, chromium, titanium, molybdenum, or tantalum. In general, the drain electrode is subjected to a passivation treatment. However, in general, the protective film is thin and the alignment film is also thin and the films have a high probability of not blocking ionic substances. Accordingly, in the case of using existing liquid crystal compositions, formation of dropping marks often occurs due to the interaction between the metal materials and the liquid crystal compositions.

On the other hand, as indicated by the results of evaluation of dropping marks in Examples below, by using a liquid crystal composition according to the first aspect of the present invention, formation of dropping marks having been problematic can be sufficiently reduced, though the specific mechanism is not yet understood.

A liquid crystal composition according to the first aspect of the present invention is suitably applied to, for example, referring to FIG. 2, a liquid crystal display element including an inverted staggered thin film transistor. In this case, an aluminum wiring is preferably used.

A liquid crystal display element including a liquid crystal composition according to the first aspect of the present invention is advantageous in that high-speed response and suppression of display failure are both achieved. In particular, the liquid crystal composition is useful for active-matrix-driving liquid crystal display elements and is applicable to liquid crystal display elements employing the VA mode, the PSVA mode, the PSA mode, the IPS mode, or the ECB mode.

A liquid crystal display according to the present invention is a display (display device) in which a liquid crystal display element according to the present invention is applied in a known manner.

### EXAMPLES

Hereinafter, the present invention will be described further in detail with reference to Examples. However, the present invention is not limited to these Examples. In the compositions of Examples and Comparative examples below, “%” denotes “% by mass”.

In EXAMPLES, the following characteristics were measured.

Tₙᵢ: nematic phase-isotropic liquid phase transition temperature (° C.)

Δn: refractive index anisotropy at 298 K

Δ∈: dielectric anisotropy at 298 K

η: viscosity at 293 K (mPa·s)

γ₁: rotational viscosity at 298 K (mPa·s)

Initial voltage holding ratio (initial VHR): voltage holding ratio (%) at 50° C. under conditions of frequency of 60 Hz and applied voltage of 4 V

Voltage holding ratio after lapse of 0.5 hours at 120° C.: voltage holding ratio (%) measured under the same conditions as in initial VHR, after holding in atmosphere at 120° C. for 0.5 hours

### [Evaluation of Burn-in]

Burn-in of a liquid crystal display element was evaluated as follows. A predetermined fixed pattern was displayed in a display area for 1440 hours, and a uniform image was then displayed on the full screen. The level of a residual image of the fixed pattern was evaluated by visual inspection on the basis of the four-level criteria described below.

A: No residual image was observed.

B: A residual image was slightly observed, but was at an acceptable level.

C: A residual image was observed, and was at an unacceptable level.

D: A residual image was observed, and was at a very poor level.

### [Evaluation of Dropping Marks]

Dropping marks of a liquid crystal display device were evaluated as follows. Dropping marks seen as white marks during displaying in black on the full screen were evaluated by visual inspection on the basis of the four-level criteria described below.

A: No residual image was observed.

B: A residual image was slightly observed, but was at an acceptable level.

C: A residual image was observed, and was at an unacceptable level.

D: A residual image was observed, and was at a very poor level.

### [Evaluation of Process Compatibility]

Process compatibility was evaluated as follows. In an ODF process, 40 pL of liquid crystal was dropped 100000 times with a constant-volume metering pump. In the “0th to 100th, 101st to 200th, 201st to 300th, . . . , 99901st to 100000th” dropping, a change in the amount of liquid crystal dropped 100 times was evaluated on the basis of the four-level criteria described below.

A: A very small change was observed (liquid crystal display elements can be produced with stability).

B: A slight change was observed, but was at an acceptable level.

C: A change was observed, and was at an unacceptable level (unevenness occurs and the yield becomes low).

D: A change was observed, and was at a very poor level (leakage of liquid crystal occurs and vacuum bubbles are formed).

### [Evaluation of Solubility at Low Temperatures]

Solubility at low temperatures was evaluated as follows. After a liquid crystal composition was prepared, 1 g of the liquid crystal composition was weighed and placed into a 2 mL sample vial. This vial was placed in a temperature controllable test chamber and subjected to cycles of temperature changes. Each cycle was constituted by, in sequence, holding at −25° C. (for an hour), heating (at 0.1° C./min), holding at 0° C. (for an hour), heating (at 0.1° C./min), holding at 20° C. (for an hour), cooling (at −0.1° C./min), holding at 0° C. (for an hour), and cooling (at −0.1° C./min) to −25° C. The liquid crystal composition was observed by visual inspection as to whether precipitate was generated and was evaluated on the basis of the four-level criteria described below.

A: No precipitate was observed for 500 or more hours.

B: No precipitate was observed for 250 or more hours.

C: A precipitate was observed within 125 hours.

D: A precipitate was observed within 72 hours.

### [Evaluation of Volatility (Apparatus Contamination)]

The volatility of a liquid crystal material was evaluated by observing the operation status of a vacuum defoaming mixer under irradiation with a stroboscope and by observing foaming of the liquid crystal material by visual inspection. Specifically, 0.75 kg of a liquid crystal composition was placed in a container having a volume of 2.0 L and designed for the vacuum defoaming mixer; under a vacuum of 3 kPa, the vacuum defoaming mixer was operated at a revolution rate of 20 S⁻¹ and at a rotation rate of 10 S⁻¹; and the evaluation was performed in terms of time until foaming started, on the basis of the four-level criteria described below.

A: The time until foaming started was 2 minutes or more. There is a low probability of apparatus contamination due to volatilization.

B: The time until foaming started was 1 minute or more and less than 2 minutes. There is a probability of slight apparatus contamination due to volatilization.

C: The time until foaming started was 20 seconds or more and less than 1 minute. Apparatus contamination occurs due to volatilization.

D: The time until foaming started was within 20 seconds. There is a probability of significant apparatus contamination due to volatilization.

### Example 1 and Comparative Example 1

Liquid crystal compositions having compositions in Table 1 were prepared and physical property values of the liquid crystal compositions were measured.

In addition, the liquid crystal compositions in Example 1 and Comparative example 1 were used to produce VA liquid crystal display elements in FIG. 1. Each liquid crystal display element includes, as an active element, an inverted staggered thin film transistor. The liquid crystal compositions were injected by a dropping process (ODF process). Furthermore, the above-described methods were used to evaluate the obtained display element in terms of burn-in, dropping marks, volatility, process compatibility, and solubility at low temperatures. The results are also described in Table 1.

TABLE 1

| | Ratio (%) | |
|---|---|---|
| | | Comparative |
| Chemical formula | Example 1 | example 1 |
| Formula (b1) | 10 | 10 |
| Formula (b2) | | 20 |
| Formula (2.1) | 20 | |
| Formula (b3) | 11 | 11 |
| Formula (b4) | 3 | 3 |
| Formula (1.1) | 12 | 12 |
| Formula (a2) | 12 | 12 |
| Formula (a3) | 2 | 2 |
| Formula (a11) | 12 | 12 |
| Formula (a12) | 12 | 12 |
| Formula (a7) | 2 | 2 |
| Formula (a8) | 4 | 4 |
| T_{NI}/° C. | 88.4 | 90.0 |
| Δn | 0.1016 | 0.1019 |
| Δε | −3.41 | −3.40 |
| η/mPa · s | 19.2 | 20.0 |
| γ₁/mPa · s | 126 | 135 |
| Initial voltage holding ratio (%) | 99.5 | 99.1 |
| Voltage holding ratio (%) | 99.0 | 98.0 |
| after lapse of 0.5 hours at 120° C. | | |
| Evaluation of burn-in | A | A |
| Evaluation of dropping marks | A | B |
| Evaluation of process compatibility | A | C |
| Evaluation of volatility | A | A |
| Evaluation of solubility at low temperatures | A | C |

The liquid crystal composition of Example 1 has a liquid crystal phase temperature range of 88.4° C., which is practical as a liquid crystal composition for TVs, has a large absolute value of dielectric anisotropy, a low rotational viscosity, and an optimal Δn. In addition, this composition is good in terms of volatility and solubility at low temperatures. Furthermore, the VA liquid crystal display element produced with the liquid crystal composition of Example 1 and having the configuration in FIG. 1 provided very good evaluation results in terms of burn-in, dropping marks, and process compatibility. The VA liquid crystal display element was also good in terms of initial voltage holding ratio and voltage holding ratio after lapse of 1 hour at 150° C.

### Example 2 and Comparative Example 2

Liquid crystal compositions having compositions in Table 2 were prepared and physical property values of the liquid crystal compositions were measured.

In addition, the liquid crystal compositions in Example 2 and Comparative example 2 were used to produce display elements as in Example 1. The display elements were evaluated in terms of burn-in, dropping marks, volatility, process compatibility, and solubility at low temperatures. The results are also described in Table 2.

TABLE 2

| | Ratio (%) | |
|---|---|---|
| | | Comparative |
| Chemical formula | Example 2 | example 2 |
| Formula (b5) | 7 | 7 |
| Formula (b1) | 12 | 12 |
| Formula (2.2) | 10 | 10 |
| Formula (b6) | 10 | 10 |
| Formula (a11) | 12 | 12 |
| Formula (a12) | 13 | 13 |
| Formula (a9) | | 19 |
| Formula (a10) | | 17 |
| Formula (1.1) | 19 | |
| Formula (1.3) | 17 | |
| T_{NI}/° C. | 68.0 | 72.0 |
| Δn | 0.1267 | 0.1512 |
| Δε | −8.06 | −7.30 |
| η/mPa · s | 18.6 | 21.0 |
| γ₁/mPa · s | 115 | 143 |
| Initial voltage holding ratio (%) | 99.5 | 99.0 |
| Voltage holding ratio (%) | 99.0 | 98.0 |
| after lapse of 0.5 hours at 120° C. | | |
| Evaluation of burn-in | A | C |
| Evaluation of dropping marks | A | C |
| Evaluation of process compatibility | A | C |
| Evaluation of volatility | A | A |
| Evaluation of solubility at low temperatures | A | C |

The liquid crystal composition of Example 2 has a liquid crystal phase temperature range of 68.0° C., which is practical as a liquid crystal composition for TVs, has a large absolute value of dielectric anisotropy, a low rotational viscosity, and an optimal Δn. In addition, this composition is good in terms of volatility and solubility at low temperatures. Furthermore, the VA liquid crystal display element produced with the liquid crystal composition of Example 2 and having the configuration in FIG. 1 provided very good evaluation results in terms of burn-in, dropping marks, and process compatibility. The VA liquid crystal display element was also good in terms of initial voltage holding ratio and voltage holding ratio after lapse of 1 hour at 150° C.

### Examples 3 to 6

Liquid crystal compositions having compositions in Table 3 were prepared and physical property values of the liquid crystal compositions were measured.

In addition, the liquid crystal compositions in Examples 3 to 6 were used to produce display elements as in Example 1. The display elements were evaluated in terms of burn-in, dropping marks, volatility, process compatibility, and solubility at low temperatures. The results are also described in Table 3.

TABLE 3

| | Ratio (%) | | | |
|---|---|---|---|---|
| | Example | Example | Example | Example |
| Chemical formula | 3 | 4 | 5 | 6 |
| Formula (1.1) | 11 | 10 | 11 | 11 |
| Formula (1.2) | 11 | 10 | 10 | 6 |
| Formula (1.3) | 12 | 10 | 12 | 6 |
| Formula (a5) | 8 | 8 | 8 | 8 |
| Formula (a6) | 7 | 7 | 7 | 7 |
| Formula (a1) | 9 | 9 | 9 | 9 |
| Formula (a2) | | 4 | | |
| Formula (a4) | 10 | 10 | | 10 |
| Formula (a11) | | | 10 | |
| Formula (a7) | | | | 11 |
| Formula (2.1) | | 5 | | 5 |
| Formula (b1) | | | 9 | 4 |
| Formula (2.2) | 14 | 9 | 14 | 13 |
| Formula (b8) | 9 | 9 | | |
| Formula (b7) | 10 | 10 | 10 | 10 |
| T_{NI}/° C. | 82.1 | 82.6 | 72.2 | 83.7 |
| Δn | 0.088 | 0.086 | 0.091 | 0.102 |
| Δε | −4.31 | −4.21 | −3.73 | −3.08 |
| η/mPa · s | 25.8 | 25.9 | 24.1 | 25.4 |
| γ₁/mPa · s | 147 | 147 | 126 | 144 |
| Initial voltage holding | 99.7 | 99.7 | 99.3 | 99.2 |
| ratio (%) | | | | |
| Voltage holding ratio (%) | 99.0 | 99.0 | 98.8 | 98.3 |
| after lapse of 0.5 hours at | | | | |
| 120° C. | | | | |
| Evaluation of burn-in | A | A | A | A |
| Evaluation of dropping | A | A | A | A |
| marks | | | | |
| Evaluation of process | A | A | A | A |
| compatibility | | | | |
| Evaluation of volatility | A | B | B | B |
| Evaluation of solubility | A | A | A | A |
| at low temperatures | | | | |

The liquid crystal compositions of Examples 3 to 6 have a liquid crystal phase temperature range of 72.2° C. to 83.7° C., which is practical as a liquid crystal composition for TVs, have a good refractive index anisotropy and a good dielectric anisotropy. The liquid crystal compositions of Examples 3, 4, 5, and 6 were very good in terms of evaluation of solubility at low temperatures.

The VA liquid crystal display element of Example 3 was very good in terms of evaluation of burn-in, dropping marks, and process compatibility. The VA liquid crystal display element of Example 4 was very good in terms of evaluation of burn-in, dropping marks, and process compatibility. The VA liquid crystal display element of Example 5 was very good in terms of evaluation of burn-in, dropping marks, and process compatibility. The VA liquid crystal display element of Example 6 was very good in terms of evaluation of burn-in, dropping marks, and process compatibility.

The VA liquid crystal display elements of Examples 3 to 6 provided good results in terms of initial voltage holding ratio and voltage holding ratio after lapse of 1 hour at 150° C.

### Examples 7 to 10

Liquid crystal compositions having compositions in Table 4 were prepared and physical property values of the liquid crystal compositions were measured.

In addition, the liquid crystal compositions in Examples 7 to 10 were used to produce display elements as in Example 1. The display elements were evaluated in terms of burn-in, dropping marks, volatility, process compatibility, and solubility at low temperatures. The results are also described in Table 4.

TABLE 4

| | Ratio (%) | | | |
|---|---|---|---|---|
| | Example | Example | Example | Example |
| Chemical formula | 7 | 8 | 9 | 10 |
| Formula (1.1) | 18 | 20 | 15 | 10 |
| Formula (1.2) | 6 | 8 | 9 | 14 |
| Formula (1.3) | 19 | 9 | 19 | 19 |
| Formula (b1) | | | | 4 |
| Formula (2.1) | | 10 | | |
| Formula (2.2) | 2 | 5 | 9 | 12 |
| Formula (b8) | 14 | 11 | | |
| Formula (a5) | 8 | 8 | 8 | 8 |
| Formula (a6) | 8 | 8 | 8 | |
| Formula (a1) | 8 | | 8 | 8 |
| Formula (a2) | 6 | 6 | 6 | |
| Formula (a3) | 6 | | 6 | 6 |
| Formula (a4) | 4 | 4 | 4 | |
| Formula (a11) | | 4 | | 5 |
| Formula (a12) | | 6 | | 4 |
| Formula (a7) | | | 7 | 6 |
| Formula (a8) | | | | 4 |
| T_{NI}/° C. | 82.5 | 77.9 | 78.0 | 74.4 |
| Δn | 0.095 | 0.098 | 0.105 | 0.114 |
| Δε | −7.17 | −5.63 | −6.05 | −5.58 |
| η/mPa · s | 40.0 | 32.3 | 45.4 | 38.0 |
| γ₁/mPa · s | 286 | 221 | 295 | 255 |
| Initial voltage holding | 99.3 | 99.2 | 99.7 | 99.7 |
| ratio (%) | | | | |
| Voltage holding ratio (%) | 98.8 | 98.3 | 99.0 | 99.0 |
| after lapse of 0.5 hours at | | | | |
| 120° C. | | | | |
| Evaluation of burn-in | A | B | A | A |
| Evaluation of dropping | A | B | A | A |
| marks | | | | |
| Evaluation of process | A | A | A | B |
| compatibility | | | | |
| Evaluation of volatility | A | A | B | B |
| Evaluation of solubility | A | A | A | B |
| at low temperatures | | | | |

The liquid crystal compositions of Examples 7 to 10 have a liquid crystal phase temperature range of 74.4° C. to 82.5° C., which is practical as a liquid crystal composition for TVs, and have a good refractive index anisotropy and a good dielectric anisotropy. The liquid crystal compositions of Examples 7, 8, and 9 were very good in terms of evaluation of solubility at low temperatures.

The VA liquid crystal display element of Example 7 was very good in terms of evaluation of burn-in, dropping marks, and process compatibility. The VA liquid crystal display element of Example 8 was very good in terms of evaluation of process compatibility. The VA liquid crystal display element of Example 9 was very good in terms of evaluation of burn-in, dropping marks, and process compatibility. The VA liquid crystal display element of Example 10 was very good in terms of evaluation of burn-in and dropping marks.

The VA liquid crystal display elements of Examples 7 to 10 provided good results in terms of initial voltage holding ratio and voltage holding ratio after lapse of 1 hour at 150° C.

### Examples 11 to 14

Liquid crystal compositions having compositions in Table 5 were prepared and physical property values of the liquid crystal compositions were measured.

In addition, the liquid crystal compositions in Examples 11 to 14 were used to produce display elements as in Example 1. The display elements were evaluated in terms of burn-in, dropping marks, volatility, process compatibility, and solubility at low temperatures. The results are also described in Table 5.

TABLE 5

| | Ratio (%) | | | |
|---|---|---|---|---|
| | Example | Example | Example | Example |
| Chemical formula | 11 | 12 | 13 | 14 |
| Formula (1.1) | 28 | 20 | 18 | 28 |
| Formula (a12) | 7 | 7 | 7 | 7 |
| Formula (a11) | | | | 7 |
| Formula (a5) | | | | 6 |
| Formula (a6) | 6 | 6 | 6 | |
| Formula (a2) | | | | 4 |
| Formula (a3) | 4 | 4 | 4 | |
| Formula (a4) | 2 | 2 | 2 | 2 |
| Formula (a15) | 4 | 6 | 10 | 7 |
| Formula (a16) | 10 | 8 | 4 | 7 |
| Formula (a7) | 8 | 8 | 8 | 8 |
| Formula (a8) | 7 | 7 | 7 | |
| Formula (b1) | 8 | 8 | 8 | 8 |
| Formula (b9) | | | 12 | |
| Formula (2.1) | 2 | 10 | | 5 |
| Formula (2.2) | 15 | 11 | 15 | 12 |
| Formula (b8) | | 4 | | |
| T_{NI}/° C. | 91.8 | 95.9 | 97.6 | 88.9 |
| Δn | 0.123 | 0.120 | 0.119 | 0.118 |
| Δε | −4.38 | −3.87 | −3.49 | −4.85 |
| η/mPa · s | 33.9 | 29.5 | 26.4 | 34.6 |
| γ₁/mPa · s | 228 | 210 | 178 | 222 |
| Initial voltage holding | 99.7 | 99.2 | 99.4 | 99.5 |
| ratio (%) | | | | |
| Voltage holding ratio (%) | 98.8 | 98.3 | 98.6 | 99.0 |
| after lapse of 0.5 hours at | | | | |
| 120° C. | | | | |
| Evaluation of burn-in | A | B | A | A |
| Evaluation of dropping | A | B | A | A |
| marks | | | | |
| Evaluation of process | A | A | A | B |
| compatibility | | | | |
| Evaluation of volatility | A | A | B | A |
| Evaluation of solubility | A | A | A | B |
| at low temperatures | | | | |

The liquid crystal compositions of Examples 11 to 14 have a liquid crystal phase temperature range of 88.9° C. to 97.6° C., which is practical as a liquid crystal composition for TVs, and have a good refractive index anisotropy and a good dielectric anisotropy. The liquid crystal compositions of Examples 11, 12, and 13 were very good in terms of evaluation of solubility at low temperatures.

The VA liquid crystal display element of Example 11 was very good in terms of evaluation of burn-in, dropping marks, and process compatibility. The VA liquid crystal display element of Example 12 was very good in terms of evaluation of process compatibility. The VA liquid crystal display element of Example 13 was very good in terms of evaluation of burn-in, dropping marks, and process compatibility. The VA liquid crystal display element of Example 14 was very good in terms of evaluation of burn-in and dropping marks.

The VA liquid crystal display elements of Examples 11 to 14 provided good results in terms of initial voltage holding ratio and voltage holding ratio after lapse of 1 hour at 150° C.

### Examples 15 to 18

Liquid crystal compositions having compositions in Table 6 were prepared and physical property values of the liquid crystal compositions were measured.

In addition, the liquid crystal compositions in Examples 15 to 18 were used to produce display elements as in Example 1. The display elements were evaluated in terms of burn-in, dropping marks, volatility, process compatibility, and solubility at low temperatures. The results are also described in Table 6.

TABLE 6

| | Ratio (%) | | | |
|---|---|---|---|---|
| | Example | Example | Example | Example |
| Chemical formula | 15 | 16 | 17 | 18 |
| Formula (b9) | | | | 14 |
| Formula (2.1) | | | 14 | |
| Formula (b2) | 14 | 14 | | |
| Formula (b1) | 13 | 6 | 12 | 12 |
| Formula (2.2) | 2 | 9 | 12 | 12 |
| Formula (1.1) | 20 | 12 | 10 | 10 |
| Formula (1.2) | | 8 | 10 | |
| Formula (a2) | 8 | 8 | 8 | |
| Formula (a1) | 8 | 9 | | |
| Formula (a3) | 1 | | 8 | 8 |
| Formula (a4) | | | | 8 |
| Formula (a11) | 10 | 10 | | 10 |
| Formula (a12) | 10 | 10 | 10 | 10 |
| Formula (a7) | 13 | 10 | 8 | 8 |
| Formula (a8) | 3 | 5 | 8 | 8 |
| T_{NI}/° C. | 88.4 | 94.5 | 89.0 | 104.9 |
| Δn | 0.129 | 0.132 | 0.119 | 0.128 |
| Δε | −4.03 | −4.07 | −3.23 | −3.15 |
| η/mPa · s | 32.4 | 35.3 | 25.9 | 26.8 |
| γ₁/mPa · s | 240 | 258 | 184 | 201 |
| Initial voltage holding | 99.7 | 99.2 | 99.4 | 99.5 |
| ratio (%) | | | | |
| Voltage holding ratio (%) | 98.8 | 98.3 | 98.6 | 99 |
| after lapse of 0.5 hours at | | | | |
| 120° C. | | | | |
| Evaluation of burn-in | A | B | A | A |
| Evaluation of dropping | A | B | A | A |
| marks | | | | |
| Evaluation of process | A | A | A | B |
| compatibility | | | | |
| Evaluation of volatility | A | A | B | B |
| Evaluation of solubility | A | A | A | B |
| at low temperatures | | | | |

The liquid crystal compositions of Examples 15 to 18 have a liquid crystal phase temperature range of 88.4° C. to 104.9° C., which is practical as a liquid crystal composition for TVs, and have a good refractive index anisotropy and a good dielectric anisotropy. The liquid crystal compositions of Examples 15, 16, and 17 were very good in terms of evaluation of solubility at low temperatures.

The VA liquid crystal display element of Example 15 was very good in terms of evaluation of burn-in, dropping marks, and process compatibility. The VA liquid crystal display element of Example 16 was very good in terms of evaluation of process compatibility. The VA liquid crystal display element of Example 17 was very good in terms of evaluation of burn-in, dropping marks, and process compatibility. The VA liquid crystal display element of Example 18 was very good in terms of evaluation of burn-in and dropping marks.

The VA liquid crystal display elements of Examples 15 to 18 provided good results in terms of initial voltage holding ratio and voltage holding ratio after lapse of 1 hour at 150° C.

### Examples 19 to 22

Liquid crystal compositions having compositions in Table 7 were prepared and physical property values of the liquid crystal compositions were measured.

In addition, the liquid crystal compositions in Examples 19 to 22 were used to produce display elements as in Example 1. The display elements were evaluated in terms of burn-in, dropping marks, volatility, process compatibility, and solubility at low temperatures. The results are also described in Table 7.

TABLE 7

| | Ratio (%) | | | |
|---|---|---|---|---|
| | Example | Example | Example | Example |
| Chemical formula | 19 | 20 | 21 | 22 |
| Formula (2.1) | 16 | 14 | 11 | 18 |
| Formula (b1) | 8 | 10 | 13 | 6 |
| Formula (1.1) | 22 | 16 | 25 | 9 |
| Formula (1.2) | 9 | 9 | 6 | 18 |
| Formula (1.3) | | 6 | | 4 |
| Formula (a1) | 8 | 8 | 8 | 8 |
| Formula (a3) | 8 | | 8 | 8 |
| Formula (a4) | 4 | 8 | 4 | 4 |
| Formula (a2) | 8 | 4 | 8 | 8 |
| Formula (a5) | | | 3 | |
| Formula (a6) | 3 | 3 | | 3 |
| Formula (a11) | 10 | 10 | 10 | 10 |
| Formula (a12) | 5 | 5 | 5 | 5 |
| Formula (a7) | | 8 | | |
| T_{NI}/° C. | 77.8 | 75.4 | 79.3 | 79.0 |
| Δn | 0.097 | 0.109 | 0.098 | 0.097 |
| Δε | −5.34 | −4.80 | −5.36 | −5.30 |
| η/mPa · s | 33.6 | 30.9 | 33.5 | 33.8 |
| γ₁/mPa · s | 199 | 204 | 202 | 204 |
| Initial voltage holding | 99.3 | 99.2 | 99.7 | 99.7 |
| ratio (%) | | | | |
| Voltage holding ratio (%) | 98.8 | 98.3 | 99 | 99 |
| after lapse of 0.5 hours at | | | | |
| 120° C. | | | | |
| Evaluation of burn-in | A | B | A | A |
| Evaluation of dropping | A | B | A | A |
| marks | | | | |
| Evaluation of process | A | A | A | B |
| compatibility | | | | |
| Evaluation of volatility | A | A | B | A |
| Evaluation of solubility | A | A | A | B |
| at low temperatures | | | | |

The liquid crystal compositions of Examples 19 to 22 have a liquid crystal phase temperature range of 99.2° C. to 99.7° C., which is practical as a liquid crystal composition for TVs, and have a good refractive index anisotropy and a good dielectric anisotropy. The liquid crystal compositions of Examples 19, 20, and 21 were very good in terms of evaluation of solubility at low temperatures.

The VA liquid crystal display element of Example 19 was very good in terms of evaluation of burn-in, dropping marks, and process compatibility. The VA liquid crystal display element of Example 20 was very good in terms of evaluation of process compatibility. The VA liquid crystal display element of Example 21 was very good in terms of evaluation of burn-in, dropping marks, and process compatibility. The VA liquid crystal display element of Example 22 was very good in terms of evaluation of burn-in and dropping marks.

The VA liquid crystal display elements of Examples 19 to 22 provided good results in terms of initial voltage holding ratio and voltage holding ratio after lapse of 1 hour at 150° C.

### Examples 23 to 26

Liquid crystal compositions having compositions in Table 8 were prepared and physical property values of the liquid crystal compositions were measured.

In addition, the liquid crystal compositions in Examples 23 to 26 were used to produce display elements as in Example 1. The display elements were evaluated in terms of burn-in, dropping marks, volatility, process compatibility, and solubility at low temperatures. The results are also described in Table 8.

TABLE 8

| | Ratio (%) | | | |
|---|---|---|---|---|
| | Example | Example | Example | Example |
| Chemical formula | 23 | 24 | 25 | 26 |
| Formula (2.1) | | | | 10 |
| Formula (b2) | 16 | 10 | 10 | |
| Formula (b1) | 12 | 12 | 12 | 12 |
| Formula (2.2) | 2 | 8 | 8 | 8 |
| Formula (1.1) | 21 | 21 | 21 | 15 |
| Formula (1.3) | | 9 | 9 | 9 |
| Formula (a11) | 9 | 9 | 9 | 9 |
| Formula (a12) | 9 | 9 | 9 | 9 |
| Formula (a13) | | | | 6 |
| Formula (a14) | | | 8 | 8 |
| Formula (a1) | 7 | | | |
| Formula (a2) | 8 | 8 | | |
| Formula (a3) | 1 | | | |
| Formula (a7) | 12 | 12 | 12 | 12 |
| Formula (a8) | 3 | 3 | 3 | 3 |
| T_{NI}/° C. | 87.1 | 78.8 | 78.3 | 84.9 |
| Δn | 0.127 | 0.126 | 0.131 | 0.134 |
| Δε | −3.93 | −4.07 | −4.07 | −3.91 |
| η/mPa · s | 31.5 | 29.3 | 27.9 | 28.9 |
| γ₁/mPa · s | 232 | 219 | 220 | 234 |
| Initial voltage holding | 99.3 | 99.2 | 99.7 | 99.7 |
| ratio (%) | | | | |
| Voltage holding ratio (%) | 98.8 | 98.3 | 99 | 99 |
| after lapse of 0.5 hours at | | | | |
| 120° C. | | | | |
| Evaluation of burn-in | A | B | A | A |
| Evaluation of dropping | A | B | A | A |
| marks | | | | |
| Evaluation of process | A | A | A | B |
| compatibility | | | | |
| Evaluation of volatility | A | A | B | A |
| Evaluation of solubility | A | A | A | B |
| at low temperatures | | | | |

The liquid crystal compositions of Examples 23 to 26 have a liquid crystal phase temperature range of 78.3° C. to 87.1° C., which is practical as a liquid crystal composition for TVs, and have a good refractive index anisotropy and a good dielectric anisotropy. The liquid crystal compositions of Examples 23, 24, and 25 were very good in terms of evaluation of solubility at low temperatures.

The VA liquid crystal display element of Example 23 was very good in terms of evaluation of burn-in, dropping marks, and process compatibility. The VA liquid crystal display element of Example 24 was very good in terms of evaluation of process compatibility. The VA liquid crystal display element of Example 25 was very good in terms of evaluation of burn-in, dropping marks, and process compatibility. The VA liquid crystal display element of Example 26 was very good in terms of evaluation of burn-in and dropping marks.

The VA liquid crystal display elements of Examples 23 to 26 provided good results in terms of initial voltage holding ratio and voltage holding ratio after lapse of 1 hour at 150° C.

The above-described configurations, combinations thereof, and the like in the embodiments are mere examples and addition, omission, or replacement of configurations and other modifications can be made without departing from the spirit and scope of the present invention. The present invention is not limited by the embodiments but is limited only by the Claims.

### INDUSTRIAL APPLICABILITY

A liquid crystal composition according to the present invention is widely applicable to the fields of liquid crystal display elements and liquid crystal displays.

### REFERENCE SIGNS LIST

1 polarizing plate
2 substrate
3 transparent electrode or transparent electrode equipped with active element
4 alignment film
5 liquid crystal
11 gate electrode
12 anodic oxidation film
13 gate insulating layer
14 transparent electrode
15 drain electrode
16 ohmic contact layer
17 semiconductor layer
18 protective film
19a source electrode 1
19b source electrode 2
100 substrate
101 protective layer

1. A liquid crystal composition having a negative dielectric anisotropy, comprising
a dielectrically negative component (A) containing a compound represented by a general formula (1) below, and
a component (B) that is a dielectrically neutral component containing at least one of compounds represented by a formula (2.1) and a formula (2.2) below, 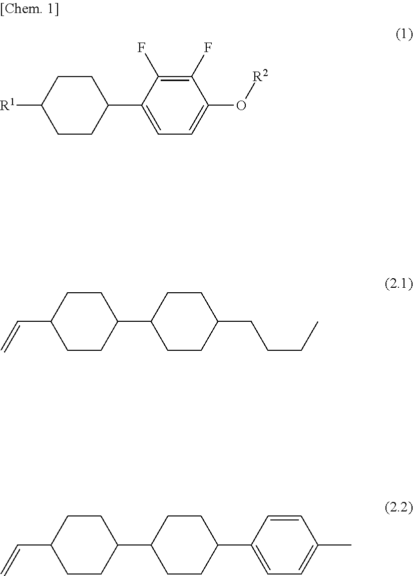
[where R¹ and R² each independently represent an alkyl group having 1 to 5 carbon atoms].

2. The liquid crystal composition according to claim 1, wherein the compound represented by the general formula (1) is a compound represented by a formula (1.1) below.

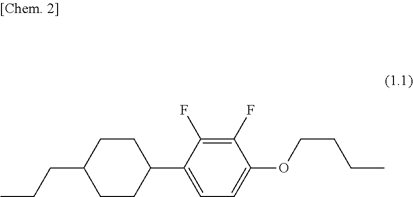

3. The liquid crystal composition according to claim 1, wherein a content of the compound represented by the formula (2.2) relative to a total mass of the liquid crystal composition is 14% by mass or more.

4. The liquid crystal composition according to claim 2, wherein a content of the compound represented by the formula (1.1) relative to a total mass of the liquid crystal composition is 23% by mass or more.

5. A liquid crystal display element comprising the liquid crystal composition according to claim 1.

6. A liquid crystal display comprising the liquid crystal display element according to claim 5.
